(19) United States
(12) Patent Application Publication
(10) Pub. No.: US 2024/0101789 A1
(43) Pub. Date: Mar. 28, 2024

(54) SILICONE PRESSURE SENSITIVE ADHESIVE COMPOSITIONS AND ARTICLES COMPRISING THE SAME

(71) Applicant: Momentive Performance Materials Inc., Waterford, NY (US)

(72) Inventors: Zhiqiang REN, Shanghai (CN); Yu SUN, Shanghai (CN); Tiberiu Mircea SICLOVAN, Waterford, NY (US)

(21) Appl. No.: 18/273,855

(22) PCT Filed: Jan. 29, 2021
(86) PCT No.: PCT/CN2021/074370

§ 371 Date: Jul. 24, 2023

(51) Int. Cl. C08K 5/55; C09J 7/38; C09J 11/06; C09J 183/04

(52) U.S. Cl. CPC C08K 5/55; C09J 7/38; C09J 11/06; C09J 183/04; C09J 2301/302

(57) ABSTRACT

The present invention relates to a silicone pressure sensitive adhesive composition comprising a boron-containing additive containing a boron-containing compound selected from the group consisting of a boroxine-based compound and a borane-based compound containing a covalent boron-nitrogen bond. The present invention also relates to an article such as a pressure sensitive adhesive tape comprising the silicone pressure sensitive adhesive composition.

### FIELD OF THE INVENTION

The present invention relates to silicone pressure sensitive adhesive (PSA) compositions, in particular silicone PSA compositions having improved adhesion especially to low energy surfaces. The present invention also relates to articles comprising the silicone pressure sensitive adhesive compositions.

### BACKGROUND OF THE INVENTION

Pressure sensitive adhesives (PSAs) have been widely used in various applications. Among the types of PSAs, silicone PSAs have attracted increasing interest due to their resistance to extremely high and low temperatures, applicability to high and low energy surfaces, and excellent insulation performance. Although the silicone PSAs are applicable to low energy surfaces such as silicone, fluoropolymer, and polyolefin materials, they provide low adhesion on such surfaces without any surface treatment, generally adhesion below 300 gf/in when peeled at 180° angle as determined according to FINAT Test Method No. 1.

In order to increase adhesion of silicone PSAs to such low energy surfaces, additives such as trialkyl borate (most often tri-n-butyl borate) have been incorporated into silicone PSAs. Although adhesion may be increased by the addition of trialkyl borate, the resultant adhesion remains insufficient if trialkyl borate is added in an additive amount conventionally used for PSAs. The adhesion may be increased with the amount of trialkyl borate. However, it is not desirable to use trialkyl borate in a large amount due to incompatibility with PSAs under high loading.

Therefore, there remains a need to develop a silicone pressure sensitive adhesive composition which comprises an alternative additive or an additive system providing the silicone pressure sensitive adhesive composition with improved adhesion to low energy surface such as silicone, fluoropolymer, and polyolefin materials especially at a relatively low additive loading.

### SUMMARY OF THE INVENTION

In an aspect, the present invention provides a silicone pressure sensitive adhesive composition comprising at least one boron-containing additive comprising a boron-containing compound selected from the group consisting of a boroxine-based compound and a borane-based compound containing a covalent boron-nitrogen bond.

In another aspect, the present invention provides a silicone pressure sensitive adhesive composition comprising at least one boron-containing additive comprising at least two members selected from the group consisting of: i) a boroxine-based compound, a borane-based compound containing a covalent boron-nitrogen bond, or a cyclic borate compound; ii) boric acid; and iii) an acyclic borate compound.

In yet another aspect, the present invention provides an article comprising the silicone pressure sensitive adhesive composition in accordance with the above aspects.

In accordance with the present invention, the silicone pressure sensitive adhesive composition containing said boron-containing additive provides an improved adhesion to low energy surfaces such as silicone, fluoropolymer, and polyolefin materials as compared to corresponding silicone pressure sensitive adhesive composition containing conventional trialkyl borate additive under the same conditions.

### BRIEF DESCRIPTION OF THE DRAWINGS

FIG. 1 is a bar chart illustrating the peel adhesion of the adhesive tapes measured in 20 minutes, 24 hours and 72 hours after application onto the silicone rubber, wherein the tapes were coated with the pressure sensitive adhesive composition, freshly prepared as described in Example 11 or after aging for eight weeks at room temperature and at a temperature of 40° C.

FIG. 2 is a bar chart illustrating the peel adhesion of the silicone pressure sensitive adhesive compositions comprising no additive, or comprising tributyl borate and trimethoxyboroxine in varying amounts.

FIG. 3 is a graph illustrating variation of the release force of the silicone pressure sensitive adhesive tapes prepared in Reference Example and Example 23 with time at room temperature.

FIG. 4 is a graph illustrating variation of the release force of the silicone pressure sensitive adhesive tapes prepared in Reference Example and Example 23 with time at a temperature of 40° C.

### DESCRIPTION OF THE INVENTION

In the specification and claims herein, the following terms and expressions are to be understood as indicated.

The singular forms “a”, “an”, and “the” include the plural, and reference to a particular numerical value includes at least that particular value, unless the context clearly dictates otherwise.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

The terms, “comprising”, “including”, “containing”, and grammatical equivalents thereof are inclusive or open-ended terms that do not exclude additional, unrecited elements or method steps, but will also be understood to include the more restrictive terms “consisting of” and “consisting essentially of”.

Other than in the working examples or where otherwise indicated, all numbers expressing amounts of materials, temperatures, time durations, quantified properties of materials, and so forth, stated in the specification and claims are to be understood as being modified in all instances by the term “about” whether or not the term “about” is used in the expression.

It will be understood that any numerical range recited herein includes all sub-ranges within that range and any combination of the various endpoints of such ranges or sub-ranges.

It will be further understood that any compound, material or substance which is expressly or implicitly disclosed in the specification and/or recited in a claim as belonging to a group of structurally, compositionally and/or functionally related compounds, materials or substances includes individual representatives of the group and all combinations thereof.

The term “alkyl” as used herein means any monovalent, saturated, linear or branched hydrocarbon group having up to about 30 carbon atoms, specifically 1 to about 20 carbons atoms, and more specifically 1 to about 10 carbon atoms, and optionally substituted with one or more halogen atoms, such as fluorine, chlorine, bromine and iodine atoms. Illustrative examples of alkyls include but are not limited to methyl, ethyl, n-propyl, isopropyl, n-butyl, isobutyl, sec-butyl, tert-butyl, n-pentyl, isopentyl, neopentyl, tert-pentyl, hexyl such as n-hexyl, heptyl such as n-heptyl, octyl such as n-octyl, isooctyl and 2-ethyl hexyl, nonyl such as n-nonyl, and decyl such as n-decyl.

The term “alkoxy” as used herein means a monovalent group of —O—alkyl with the alkyl being defined as above.

The term “hydroxylalkyl” as used herein means any alkyl group (as defined above) in which one or more hydrogen atoms have been substituted by the same number of hydroxyl. Illustrative examples of hydroxylalkyl include any alkyl group (as defined above) in which one of the hydrogen atoms bonded to the terminal carbon atom has been substituted with one hydroxyl such as —alkyl—OH.

The term “alkoxyalkyl” as used herein means any alkyl group (as defined above) in which one or more hydrogen atoms have been substituted by the same number of alkoxy (as defined above). Illustrative examples of alkoxyalkyl include any alkyl group (as defined above) in which one of the hydrogen atoms bonded to the terminal carbon atom has been substituted with one alkoxy, such as —alkyl—O—alkyl.

The term “aryl” as used herein means any monovalent aromatic hydrocarbon group having about 6 to about 30 carbon atoms, specifically about 6 to about 20 carbon atoms, and more specifically about 6 to about 12 carbon atoms, including alkylaryl and arylalkyl. Illustrative examples of aryls include phenyl, naphthalenyl, benzyl, phenethyl, o-, m- and p-tolyl, and xylyl.

The term “divalent linking group” as used herein means any divalent, saturated, linear or branched hydrocarbon group having up to about 30 carbon atoms, specifically 1 to about 20 carbons atoms, and more specifically 2 to about 10 carbon atoms, and optionally containing one or more heteroatoms selected from the group consisting of oxygen, nitrogen, silicon, sulfur, fluorine, chlorine, bromine and iodine. Illustrative examples of divalent linking group include alkylene, oxyalkylene group, and thioalkylene.

The term “cyclic” as used herein refers to compounds which include any molecules having at least three atoms joined together to form a ring (excluding a phenyl ring). The ring may be, for example, a three-membered to ten-membered ring, specifically a four-membered to eight-membered ring, more specifically, four-, five-, six-, seven-, or eight-membered ring.

The term “acyclic” as used herein refers to compounds which are free from a cyclic structure (excluding a phenyl ring). For example, in some embodiments, the acyclic compound herein may have a benzyl or a phenyl group.

The viscosity as described herein is measured at 25 degrees Celsius using a Brookfield viscometer, unless otherwise indicated.

In an aspect, the present invention provides a silicone pressure sensitive adhesive composition comprising at least one boron-containing additive. The boron-containing additive comprises a boron-containing compound selected from the group consisting of a boroxine-based compound and a borane-based compound containing a covalent boron-nitrogen bond.

The “boroxine-based compound” as used herein refers to a compound having a six-membered ring formed by three boron atoms and three oxygen atoms connected alternately.

The “borane-based compound containing a covalent boron-nitrogen bond” as used herein

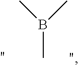

refers to an organoboron compound containing one boranyl of wherein the boranyl is at least directly connected to one nitrogen atom via a covalent bond.

In an embodiment, the boroxine-based compound may have the general formula (I):

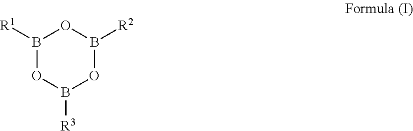

wherein R¹, R² and R³ each independently is a hydrogen atom; a hydroxyl; or a monovalent group having up to about 30 carbon atoms, specifically up to about 20 carbon atoms, more specifically up to about 10 carbon atoms, selected from the group consisting of an alkyl group, an alkoxy group, a hydroxylalkyl, an alkoxyalkyl, or —R⁸—N(R⁹)(R¹⁰) where R⁸ is a direct bond or a divalent linking group, and R⁹ and R¹⁰ each independently is a hydrogen atom, an alkyl, a hydroxylalkyl, or an alkoxyalkyl;

preferably, R¹, R² and R³ each independently is a monovalent group having up to about 20 carbon atoms selected from the group consisting of an alkoxy group, an alkoxyalkyl, or —R⁸—N(R⁹)(R¹⁰) where R⁸ is a direct bond, an alkylene group or an oxyalkylene group (in which the oxy group is bonded to the N atom via the alkylene), and R⁹ and R¹⁰ each independently is a hydrogen atom, an alkyl, or an alkoxyalkyl; and more preferably, a monovalent group selected from the group consisting of an alkoxy group having up to about 10 carbon atom, specifically 1 to about 8 carbon atoms, more specifically 1 to about 6 carbon atoms, or —R⁸—N(R⁹)(R¹⁰) where R⁸ is a direct bond or an oxyalkylene group having about 2 to about 6 carbon atoms, and R⁹ and R¹⁰ each independently is a hydrogen atom, an alkyl having 1 to about 6 carbon atoms, or an alkoxyalkyl having 2 to about 8 carbon atoms.

In one preferable embodiment, the boroxine-based compound may have general formula (I-1):

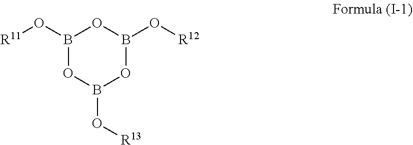

wherein R¹¹, R¹² and R¹³ each independently is a monovalent group having up to about 20 carbon atoms selected from the group consisting of an alkyl, or —R¹⁴—N(R¹⁵)(R¹⁶) where R¹⁴ is an alkylene group, and R¹⁵ and R¹⁶ each independently is a hydrogen atom, an alkyl, or an alkoxyalkyl; and preferably, R¹¹, R¹² and R¹³ each independently is an alkyl having 1 to about 10 carbon atoms, preferably 1 to about 8 carbon atoms, and more preferably 1 to about 6 carbon atoms.

In another preferable embodiment, the boroxine-based compound may have general formula (I-2)

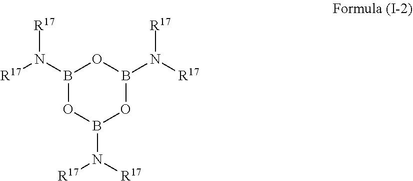

wherein each R¹⁷ is independently an alkyl or an alkoxyalkyl having up to 20 carbon atom, or a hydrogen atom; preferably, each R¹⁷ is independently a hydrogen atom or an alkyl having up to 10 carbon atom, preferably 1 to about 8 carbon atoms, and more preferably 1 to about 6 carbon atoms.

The boroxine-based compounds may be prepared by various methods known in the art. For example, the boroxine-based compounds may be prepared by heating a boronic acid having a substituent to form a boroxine compound having the corresponding substituent on the B atom; or by reacting triorganoboranes with boric oxide to give the corresponding boroxine compound. As a further illustrative example, the boroxine compound having formula (I-1) can be also prepared by reacting boric acid with trialkyl borate in a stoichiometric ratio.

In another embodiment, the borane-based compound containing a covalent boron-nitrogen bond may have general formula (II):

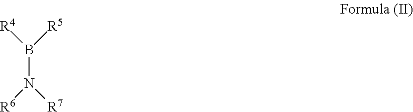

wherein R⁴ and R⁵ each independently is a monovalent group having up to about 30 carbon atoms, specifically up to about 20 carbon atoms, more specifically up to about 10 carbon atoms, selected from the group consisting of an alkyl group, an alkoxy group, a hydroxylalkyl, an alkoxyalkyl, or —R⁸—N(R⁹)(R¹⁰) where R⁸ is a direct bond or a divalent linking group, and R⁹ and R¹⁰ each independently is a hydrogen atom, an alkyl, a hydroxylalkyl, or an alkoxyalkyl; preferably, R⁴ and R⁵ each independently is a monovalent group having up to about 20 carbon atoms selected from the group consisting of an alkoxy group, or —R⁸—N(R⁹)(R¹⁰) where R⁸ is a direct bond or an alkylene group, and R⁹ and R¹⁰ each independently is a hydrogen atom, an alkyl, or an alkoxyalkyl; more preferably, R⁴ and R⁵ each independently is an alkoxy group having up to about 10 carbon atoms, specifically 1 to about 8 carbon atoms, and more specifically 2 to about 6 carbon atoms, or —R⁸—N(R⁹)(R¹⁰) where R⁸ is a direct bond, and R⁹ and R¹⁰ each independently is a hydrogen atom, or an alkyl having up to about 10 carbon atoms, specifically 1 to about 8 carbon atoms, and more specifically 1 to about 6 carbon atoms;

optionally R⁴ and R⁵ taken together form a ring containing an alkylene group of up to about 10 carbon atoms, preferably about 2 to about 6 carbon atoms, and more preferably about 2 to about 5 carbon atoms, bonded to the B atom of Formula (II) via an oxygen atom; and

R⁶ and R⁷ each independently is an alkyl, a hydroxylalkyl or an alkoxyalkyl each independently having up to about 30 carbon atoms, specifically up to about 20 carbon atoms, and more specifically up to about 10 carbon atoms, or a hydrogen atom; preferably R⁶ and R⁷ each independently is a hydrogen atom, or an alkyl having up to about 10 carbon atoms, specifically 1 to about 8 carbon atoms, and more specifically 1 to about 6 carbon atoms.

In one preferable embodiment, the borane-based compound containing a covalent boron-nitrogen bond may have general formula (II-1):

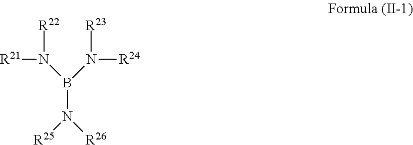

wherein R²¹, R²², R²³, R²⁴, R²⁵ and R²⁶ each independently is a an alkyl, a hydroxylalkyl or an alkoxyalkyl each independently having up to about 20 carbon atoms, or a hydrogen atom; preferably, R²¹, R²², R²³, R²⁴, R²⁵ and R²⁶ each independently is a an alkyl having up to about 10 carbon atoms, or a hydrogen atom; more preferably an alkyl having up to about 10 carbon atoms, preferably 1 to about 8 carbon atoms, and more preferably 1 to about 6 carbon atoms.

In another preferable embodiment, the borane-based compound containing a covalent boron-nitrogen bond may have general formula (II-2):

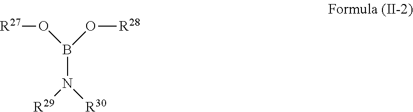

wherein R²⁷ and R²⁸ each independently is a monovalent group having up to 20 carbon atoms selected from the group consisting of an alkyl, or —R³¹—N(R³²)(R³³) where R³¹ is an alkylene group, and R³² and R³³ each independently is a hydrogen atom, an alkyl, or an alkoxyalkyl; preferably, R²⁷ and R²⁸ each independently is an alkyl having up to 10 carbon atoms, preferably 1 to about 8 carbon atoms, and more preferably 1 to about 6 carbon atoms;

optionally R²⁷ and R²⁸ taken together form a ring containing an alkylene group of 1 to about 6 carbon atoms, preferably about 2 to about 6 carbon atoms, and more preferably about 2 to about 5 carbon atoms, bonded to the O atoms of Formula (II-2); preferably, R²⁷ and R²⁸ taken together form a ring containing —CH₂CH₂—, —CH₂CH₂CH₂—, —CH₂CH(CH₃)—, —CH(CH₃)CH(CH₃)—, —CH₂CH(CH₃)CH₂—, or —CH₂C(CH₃)₂CH₂— bonded to the O atoms of formula (II-2); and

wherein R²⁹ and R³⁰ each independently is a an alkyl, a hydroxylalkyl or an alkoxyalkyl each independently having up to 20 carbon atoms, or a hydrogen atom; preferably an alkyl having up to about 10 carbon atoms, or a hydrogen atom; more preferably an alkyl having up to about 10 carbon atoms, preferably 1 to about 8 carbon atoms, and more preferably 1 to about 6 carbon atoms.

The borane-based compound containing a covalent boron-nitrogen bond may be prepared by various methods known in the art. For example, the covalent boron-nitrogen bond in the borane-based compounds may be introduced by reacting a halogenated borane with the corresponding secondary amine compound to replace the halogen atom bonded to the boron atom with the corresponding amino group. Further, the boron-oxygen bond in the borane-based compound having the covalent boron-nitrogen bond can be introduced by, for example, subjecting a tri(dialkylamino)borane compound with an aliphatic alcohol compound to alcohol-amine exchange reaction. As an illustrative example, the borane-based compound having formula (II-2) can be prepared by reacting tri(dimethylamino)borane with a monohydric alcohol in stoichiometric ratio to form a acyclic one, or with an alkylene glycol in stoichiometric ratio to form a cyclic one. Reference can be made to Gerrard, W. et al, “Chemistry of Certain Novel Organic Boron Compounds”, Chemistry & Industry, 292-3 (1958), which is incorporated by reference in its entirety herein.

The at least one boron-containing additive selected from the boroxine-based compound and the borane-based compound may be present in an amount of about 0.01 to about 10 weight percent, preferably from about 0.05 to about 9 weight percent, and more preferably 0.1 to about 8 weight percent based on the total weight of the silicone pressure sensitive adhesive composition.

The boroxine-based compound defined above under formula (I) or the borane-based compound containing a covalent boron-nitrogen bond defined above under formula (II) increases the peel adhesion of the silicone pressure sensitive adhesive composition of the present invention to silicone rubbers by at least about 45%, in some embodiments by about 65% or higher, and in further embodiments about 80% or higher, or even 100% or higher, as compared to conventional trialkyl borate additive under the same conditions.

In other embodiments, the at least one boron-containing additive comprises at least two members (hereinafter referred to as the first member and the second member) selected from the group consisting of:
i) the boroxine-based compound, the borane-based compound containing a covalent boron-nitrogen bond, or a cyclic borate compound;
ii) boric acid; and
iii) an acyclic borate compound.

The term “cyclic borate” as used herein refers to a cyclic ester or salt of boric acid (H₃BO₃), alkylboric acid or arylboric acid. The terms “alkylboric acid” and “arylboric acid” as used herein refer to an alkyl- and aryl-substituted boric acid compound wherein one of the three hydroxyl groups bonded to the boron atom has been substituted with an alkyl having 1 to about 6 carbon atoms or an aryl having about 6 to about 12 carbon atoms, respectively. The cyclic borate may contain one, two or three rings in one molecule.

In one embodiment, the cyclic borate compound may have general formula (III):

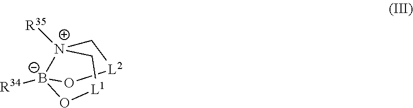

wherein R³⁴ and R³⁵ each independently is an alkyl having 1 to 6 carbon atoms or an aryl having 6 to 12 carbon atoms, optionally, R³⁴ and R³⁵ taken together form a ring containing a divalent group of formula —O—L³—CH₂—, with the —L³— group being bonded to the B atom of formula (III) via the oxygen atom;

L¹, L² and L³ each independently is a divalent group of formula —[C(O)]ₘCₙH₂ₙ— where m is 0 or 1, and n is an integer of 0 to 4, provided that when R³⁴ and R³⁵ taken together form a ring, m defined for at least one of L¹, L² and L³ is 0.

In one embodiment, the cyclic borate compound is selected from compounds having formula (III) wherein R³⁴ and R³⁵ each independently is an alkyl having 1 to 6 carbon atoms, preferably an alkyl having 1 to 4 carbon atoms; L¹ and L² each independently is a divalent group of formula —[C(O)]ₘCₙH₂ₙ— where m is 0 or 1, and n is an integer of 0 to 3, provided that m+n is at least 1. Preferably, L¹ and L² each independently is a divalent group of —CH₂—, —CH₂CH₂—, —CH(CH₃)—, —C(CH₃)₂—, —C(O)—, or —C(O)CH₂—.

In another embodiment, the cyclic borate compound may have general formula (III-1):

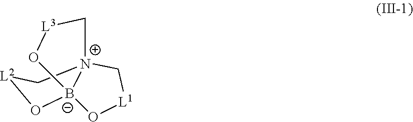

wherein L¹ and L² each independently is a divalent group of formula —[C(O)]ₘCₙH₂ₙ—where m is 0 or 1, and n is an integer of 0 to 3, provided that m+n is at least 1; preferably, L¹ and L² each independently is a divalent group of —CH₂—, —CH₂CH₂—, —CH(CH₃)—, —C(CH₃)₂—, —C(O)—, or —C(O)CH₂—;

L³ is —CH₂—, —CH₂CH₂—, —CH(CH₃)—, or —C(CH₃)₂—.

The cyclic borate compound can be prepared, for example, by reacting boric acid, alkylboric acid (such as methylboronic acid or ethylboronic acid) or arylboric acid (such as phenylboronic acid) with an amine compound containing one to three hydroxyl groups, one or two carboxyl groups, or combinations thereof. Illustrative examples of such an amine compound include but are not limited to tri(hydroxylalkyl)amine such as triethanolamine, tri-n-propanolamine, or tri-iso-propanolamine; hydroxylalkyliminodicarboxylic acid such as (2-hydroxyethyl)iminodiacetic acid; alkyliminodicarboxylic acid such as N-methyliminodiacetic acid or N-ethyliminodiacetic acid.

The term “acyclic borate” as used herein refers to an acyclic compound derived from boric acid, typically of which is trialkyl borate well known in the art. The alkyl in trialkyl borate may each independently have 1 to about 20 carbon atoms, specifically 1 to about 10 carbon atoms, and more specifically 1 to about 6 carbon atoms. The term “trialkyl borate” as used herein includes both a single trialkyl borate and also a mixture of trialkyl borates having different alkyls. Illustrative examples of the acyclic borate compound include but are not limited to trimethyl borate, triethyl borate, tri-n-propyl borate, tri-iso-propyl borate, tri-n-butyl borate, tri-iso-butyl borate, trioctyl borate, tridodecyl borate, trioctadecyl borate, or combinations thereof; with trimethyl borate, triethyl borate, tri-n-propyl borate, tri-iso-propyl borate, tri-n-butyl borate, tri-iso-butyl borate or combinations thereof being preferred.

The acyclic borate compound and boric acid may be collectively referred to as acyclic boric compounds herein.

In one embodiment, the boron-containing additive comprises one or more compounds from the above i) as the first member and the above ii) as the second member; or comprises one or more compounds from the above i) as the first member and one or more compounds from the above iii) as the second member; or comprises the above ii) as the first member and one or more compounds from the above iii) as the second member. Illustrative examples of the boron-containing additive according to this embodiment include but are not limited to: the boroxine-based compound having formula (I) as the first member in combination with trialkyl borate as the second member; the boroxine-based compound having formula (I) as the first member in combination with boric acid as the second member; the borane-based compound containing a covalent boron-nitrogen bond having formula (II) as the first member in combination with trialkyl borate as the second member; the borane-based compound containing a covalent boron-nitrogen bond having formula (II) as the first member in combination with boric acid as the second member; boric acid as the first member in combination with trialkyl borate as the second member; the cyclic borate as the first member in combination with trialkyl borate as the second member; and the boroxine-based compound having formula (I) and the borane-based compound containing a covalent boron-nitrogen bond having formula (II) as the first member in combination with trialkyl borate as the second member. The boron-containing additive according to this embodiment provides the silicone pressure sensitive adhesive composition with an improved adhesion to low energy surface such as silicone, fluoropolymer, and polyolefin materials.

In an embodiment, the boron-containing additive comprises the boroxine-based compounds having formula (I), the cyclic borate compound, boric acid, or combinations thereof as the first member; and an acyclic borate compound selected from trialkyl borate as the second member. Illustrative examples of the boron-containing additive according to this embodiment include but are not limited to: the boroxine-based compound having formula (I-1) as the first member in combination with trialkyl borate as the second member; boric acid as the first member in combination with trialkyl borate as the second member; and the cyclic borate compound having formula (III) as the first member in combination with trialkyl borate as the second member. The two members in boron-containing additive according to this embodiment achieve a synergy effect in improving adhesion of the silicone pressure sensitive adhesive composition to low energy surface such as silicone, fluoropolymer, and polyolefin materials.

In another embodiment, the boron-containing additive comprises boric acid, the cyclic borate compound having formula (III-1) or combinations thereof as the first member; and an acyclic borate compound especially trialkyl borate as the second member. These two members achieve a remarkable synergistic effect in improving adhesion of the silicone pressure sensitive adhesive composition to low energy surfaces such as silicone, fluoropolymer, and polyolefin materials.

In another embodiment, the boron-containing additive comprises the boroxine-based compound having formula (I-1) as the first member and trialkyl borate as the second member. These two members achieve a remarkable synergistic effect in improving adhesion of the silicone pressure sensitive adhesive composition to low energy surfaces such as silicone, fluoropolymer, and polyolefin materials. Besides, the silicone pressure sensitive adhesive composition comprising the boron-containing additive according to this embodiment has a clear appearance and long-term stability.

The weight ratio of the first member to the second member may be varied over a wide range. Typically, the weight ratio (the first member: the second member) may range from about 1:100 to about 1:1, preferably from about 1:70 to about 1:1. The weight ratio (the first member: the second member) may be, for example, from about 1:60 to about 1:2, such as about 1:50 to about 1:3, or in another embodiment from about 1:40 to about 1:4.

In other embodiments, the boron-containing additive may comprise all of the three members of the above i), ii) and iii). Preferably, the acyclic borate compound iii) especially trialkyl borate is present in an amount of about 50 wt % to about 99 wt %, specifically about 60 wt % to about 98 wt % relative to the total amount of the boron-containing additive.

In addition to the at least one boron-containing additive, the silicone pressure sensitive adhesive composition further comprises a silicone pressure sensitive adhesive (silicone PSA). The silicone PSA may be any one known in the art. The silicone PSA generally comprises a polyorganosiloxane gum and a silicone resin; and may optionally further comprise a curing catalyst, a solvent, fillers, and other optional component(s) as necessary. The pressure sensitive adhesive composition may be cured by a radical reaction or a hydrosilylation reaction.

The term “polyorganosiloxane gum” as used herein refers to polyorganosiloxane having a viscosity of at least about 300,000 cps, specifically from about 500,000 cps to about 150,000,000 cps, more specifically from about 1,000,000 cps to about 100,000,000 cps and even more specifically from about 2,000,000 cps to about 80,000,000 cps. The polyorganosiloxane gum may have a number average molecular weight of at least 100,000, specifically from about 120,000 to about 1,000,000, and specifically from about 150,000 to about 800,000. The polyorganosiloxane gum may comprise one or more functional groups selected from the group consisting of hydroxyl, alkenyl such as vinyl, alkoxy, alkoxyalkenyl and hydride.

Suitable polyorganosiloxane gum may have the following general formula:

R₂R^{F}SiO(R₂SiO)ₓ(RR^{F}SiO)_{y}SiR^{F}R₂ (IV)

wherein each R is independently a monovalent hydrocarbon group having up to about 12 carbon atoms, for example, an alkyl group having from 1 to about 6 carbon atoms such as methyl, ethyl, and propyl; or an aryl group having from about 6 to about 12 carbon atoms such as phenyl;

each R^{F} is independently a hydroxyl, a hydride, an alkenyl such as vinyl, an alkoxy or an alkoxyalkenyl group having from 1 to about 10 carbon atoms;

x and y is independent 0 or a positive number of up to 10000, specifically 1 to about 8000, more specifically 10 to about 5000,with the proviso that x+y is at least 1000.

Illustrative examples of polyorganosiloxane gum include but are not limited to polydimethylsiloxane and polydimethylsiloxane-plydiphenylsiloxane copolymer terminated with hydroxyl groups, and vinyl functionalized polyorganosiloxane.

The term “silicone resin” as used herein refers to any organopolysiloxane containing at least one (RSiO_{3/2}) or (SiO_{4/2}) siloxy unit. In an embodiment, the silicone resin comprises at least one M unit of the formula M=R₃SiO_{1/2}, and at least one unit selected from the group consisting of a T unit of the formula T=RSiO_{3/2} and a Q unit of the formula Q=SiO_{4/2}, and optionally at least one D unit of the formula D=R₂SiO_{2/2}, where R each independently is a monovalent hydrocarbon group of from 1 to about 6 carbon atoms, for example, alkyl of 1 to about 4 carbon atoms such as methyl, or phenyl.

The molecular weight of the silicone resin is not limited and may be varied over a wide range. For example, the silicone resin may have a number average molecular weight of about 300 or higher, specifically about 500 to about 50,000, and more specifically about 1,000 to about 30,000.

In one embodiment, the silicone resin is MQ resin comprising at least one Q unit and at least one M unit. The ratio of the M unit to the Q unit may be, for example, from about 0.5:1 to about 1.5:1, specifically from about 0.6:1 to about 1.2:1, more specifically from about 0.7:1 to about 1.1:1 and even more specifically from about 0.85:1 to about 1.0:1. The MQ resin may further comprise D unit, T unit, or both, in an amount of, for example 20 mol % or less, specifically 10 mol % or less, and more specifically 5 mol % or less of the total number of the units in the silicone resin.

Generally, the MQ resin may be functionalized with a hydroxyl group. The total hydroxyl content in the MQ resin is typically about 1-10 wt %, specifically about 2-8 wt %, and more specifically about 2-5 wt %. The MQ resin may also be optionally functionalized with one or more functional groups selected from the group consisting of alkenyl such as vinyl, alkoxy, alkoxyalkenyl and hydride.

In another embodiment, the silicone resin is MT resin comprising at least one T unit and at least one M unit, preferably MDT resin further comprising at least one D unit in addition to the T unit and the M unit. The MT resin and the MDT resin may also comprise Q unit. The amount of the T unit and the D unit (if present) may be, for example, 60 mol % or more, specifically 70 mol % or more, and more specifically 80 mol % or more of the total number of the units in the silicone resin.

In the MT resin or MDT resin, the molar ratio of the hydrocarbon group “R” to Si atom (R/Si) is typically from about 1.0:1 to about 1.8:1, specifically from about 1.1:1 to about 1.7:1, and more specifically from about 1.2:1 to about 1.6:1. In an illustrative example, the hydrocarbon group “R” includes methyl and phenyl (Ph), with the ratio of phenyl to hydrocarbon group (Ph/R) being, for example, from about 0.1:1 to about 0.8:1, preferably from about 0.2:1 to about 0.7:1, and more preferably from about 0.2:1 to about 0.6:1.

The MT resin or MDT resin may optionally be functionalized with one or more functional groups selected from the group consisting of hydroxyl, alkenyl such as vinyl, alkoxy, alkoxyalkenyl and hydride.

The silicone resin may be present in the silicone pressure sensitive adhesive composition in an amount of about 50 parts by weight to about 150 parts by weight, specifically about 70 parts by weight to about 130 parts by weight, and more specifically about 80 parts by weight to about 120 parts by weight, based on 100 parts by weight of the polyorganosiloxane gum.

A large number of suitable silicone pressure sensitive adhesives comprising both polyorganosiloxane gum and silicone resin are commercially available. Illustrative examples of these silicone pressure sensitive adhesives include but are not limited to: SilGrip™ series from Momentive Performance Materials, for example SilGrip™ PSA 5080, PSA 510, PSA 518, PSA 529, PSA590LD, PSA595, PSA610, PSA6573A, PSA6574, PSA810, PSA820 and PSA915.

The silicone pressure sensitive adhesive composition herein preferably comprises curing catalysts to improve its performance such as cohesive strength, although the catalysts may not be used in some embodiments. The curing catalysts used herein are not particularly limited and are generally selected depending on the curing mechanism of the silicone pressure sensitive adhesive. For example, if the silicone pressure sensitive adhesive is cured by a radical reaction, the curing catalyst may include, for example, peroxides such as inorganic and organic peroxides. Illustrative examples of peroxides include but are not limited to aryl peroxide, such as dibenzoyl peroxide, 2,4-dichlorobenzoyl peroxide and combinations thereof If the silicone pressure sensitive adhesive is cured by a hydrosilylation reaction, the curing catalyst may include, for example, precious metal catalysts such as those which use ruthenium, rhodium, palladium, osmium, iridium, and platinum, and complexes of these metals. Illustrative examples of hydrosilylation catalysts include, but are not limited to: Ashby catalysts; Lamoreax catalysts; Karstedt catalysts; Modic catalysts; and Jeram catalysts and combinations thereof.

The curing catalysts may be present in an amount of up to about 10 parts by weight, preferably from about 0.1 to about 8 parts by weight, and more preferably from about 0.5 to about 5 parts by weight, based on 100 parts by weight of the polyorganosiloxane gum.

A suitable solvent can be included to adjust the viscosity of the silicone pressure sensitive adhesive composition, although a solvent-free silicone pressure sensitive adhesive is also applicable herein. Illustrative examples of the solvent include but are not limited to, aromatic solvents such as toluene and xylene, aliphatic solvents such as hexane, octane and isoparaffine, ketones such as methyl ethyl ketone and methyl isobutyl ketone, esters such as ethyl acetate and isobutyl acetate, and ethers such as diisopropyl ether and 1,4-dioxane, or combinations thereof. The amount of the solvent generally depends on the viscosity of the gum and the means for applying the silicone pressure sensitive adhesive composition. As an illustrative example, the solvent contained in an amount of about 40 wt % to about 70 wt % will provide a solution with a viscosity suitable for coating. The solvent may be removed in a drying step at a relatively low temperature before curing the silicone PSA composition.

Illustrative examples of the filler may include, but are not limited to quartz powder, zinc oxide, aluminum hydroxide, titanium dioxide, light calcium carbonate or combinations thereof to increase cohesive strength and to lower cost. The amount of the filler may vary over a wide range depending on the silicone PSA, the nature of the filler and the intended use. For example, the filler may be present in an amount of 0 to about 150 parts by weight and preferably about 1 to about 100 parts by weight, based on 100 parts by weight of the polyorganosiloxane gum.

Other optional components may include, for example, a condensing promoter for facilitating condensation reaction of silanol groups such as dibutyl tin diacetate; non-reactive polyorganosiloxanes such as polydimethylsiloxanes and silsesquioxane resins; antioxidants such as phenol type, quinone type, amine type, phosphorus type, phosphite type, sulfur type, and thioether type antioxidants; photostabilizers such as triazole type and benzophenone type photostabilizers; flame retardants such as phosphate ester type, halogen type, phosphorus type, and antimony type flame retardants; and dyes and pigments.

Some optional additives are commercially available. Illustrative examples of the commercial additives include but are not limited to an anchorage promoter for improving adhesion of the silicone PSAs to the substrate, such as AnchorSil™ 2000, SilForce™ SL6020 or SilForce™ SS4300C for especially polyester substrate, or SilQuest™ A-186 silane; and a silicone resin additive for controlling tacking such as SilGrip™ SR500 resin and SR545 resin, all the above available from Momentive Performance Materials.

The silicone pressure sensitive adhesive composition described herein can have an improved peel adhesion to low energy surface such as silicone, fluoropolymer, and polyolefin materials. In one embodiment, the low energy surface herein can be silicone rubbers. The adhesion to silicone rubbers peeled at an angle of 180 degrees as determined according to FINAT Test Method No. 1 may be at least about 660 gf/inch, preferably from about 700 gf/inch to about 1500 gf/inch, more preferably from about 800 gf/inch to about 1400 gf/inch and even more preferably from about 1000 gf/inch to about 1300 gf/inch.

The silicone pressure sensitive adhesive composition according to the present invention may be prepared by a process comprising mixing the at least one boron-containing additive with the polyorganosiloxane gum and the silicone resin, and optionally any of the optional components as described above and herein such as the curing catalyst, the solvent, the fillers and other additives. The mixing may be carried out at room temperature or an elevated temperature of not higher than about 50° C., such as about 30° C. to about 45° C., for a period effective to obtain a uniform mixture, for example, from several seconds to several hours. When two or more boron-containing additives are used, they may be added together or separately. The components to be mixed may be added in any order. For example, the boron-containing additive may be added together with or separately from the curing catalyst into a dispersion of the polyorganosiloxane gum and the silicone resin with or without the solvent in one embodiment; and may be mixed with the polyorganosiloxane gum into which the silicone resin and the curing catalyst are then added simultaneously or sequentially with or without the solvent. In a specific embodiment, the process for preparing the adhesive composition comprises dispersing the polyorganosiloxane gum and the silicone resin in the solvent, preferably the organic solvent, such as toluene, xylene, heptane or a combination thereof; and adding the boron-containing additive and the curing catalyst, optionally with fillers or other additives into the dispersion.

In another aspect, the present invention provides an article such as a pressure sensitive adhesive tape comprising the silicone pressure sensitive adhesive composition described herein. The pressure sensitive adhesive tape may be made by applying the silicone pressure sensitive adhesive composition to a substrate, such as a rigid substrate or a flexible substrate for example a polymer substrate. Illustrative examples of the polymer substrate include but are not limited to a polyester substrate such as polyethylene terephthalate or polybutylene terephthalate substrate. The substrate may be used as it is. Alternatively, the substrate may be pre-treated, for example by corona; or coated with a primer such as SilForce™ SS4191A and SilForce™ SS6800 from Momentive Performance Materials.

As the silicone pressure sensitive adhesive compositions described herein have improved adhesion to low energy surface such as silicone, fluoropolymer, and polyolefin materials, the pressure sensitive adhesive tapes comprising such compositions can be used widely in adhesion materials having low energy surface, especially in adhesion of silicone materials. Thus, the present invention further relates to an article comprising the silicone pressure sensitive adhesive composition described herein on low energy surface such as silicone, fluoropolymer, and polyolefin materials, especially on silicone rubbers.

### EXAMPLES

The present invention will be more specifically explained with reference to Examples, but these Examples shall not be construed as to limit the scope of the present invention. In the descriptions below, “part(s)” and “%” denotes “part(s) by weight” and “% by weight”, unless otherwise stated. Besides, all viscosities were measured at 25° C. using a Brookfield rotational viscometer and were reported in centipoises (cps), unless otherwise stated.

### Preparation Example 1—Synthesis of Dimethyl Dibutoxyboranyl Amine

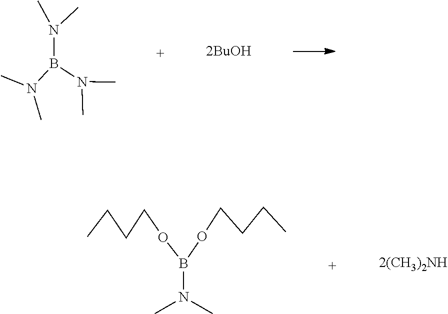

In a fume hood, tris(dimethylamino)borane (1.00 g, 0.007 mol, Sigma-Aldrich) and n-BuOH (1.04 g, 0.014 mol) were added into a 25 ml flask at room temperature. Upon shaking, a gas was generated and escaped from the flask. The reaction was continued for around one day until no gas escaped. A clear liquid was obtained and ready for use.

### Preparation Example 2—Synthesis of Dimethyl Dioxaborolanyl Amine

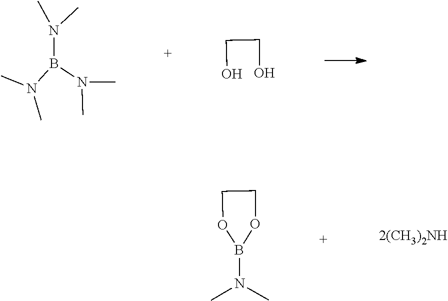

In a fume hood, tris(dimethylamino)borane (1.00 g, 0.007 mol, Sigma-Aldrich) and ethylene glycol (0.43 g, 0.007 mol) were added into a 25 ml flask at room temperature. Upon shaking, a gas was generated and escaped from the flask. The reaction was continued for around one day until no gas escaped. A white solid was obtained and ready for use.

### Preparation Example 3—Synthesis of Tetraacetyl Diborate

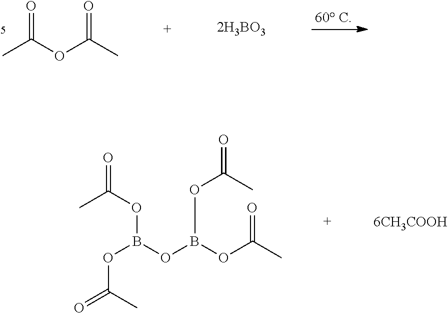

Acetic anhydride (24.4 g, 0.24 mol, Sinopharm) and boric acid (4.8 g, 0.08 mol, Sinopharm) were added into a 100 ml 3-neck flask equipped with mechanical stirrer and thermocouple. The temperature was slowly increased to 59° C. by hot water bath. After the hot water bath was removed, the temperature continued rising from 59° C. to 60.5° C. spontaneously in around 10 min. Then, a cold water bath was used immediately to reduce the temperature to 55° C. The reaction was stabilized at a temperature of 59-60° C. and kept at reflux for 1 hour to finish the reaction.

The resultant was cooled to 5° C., vacuum filtered and washed with 1:1 of heptane/ethyl acetate. After drying in an oven at 40° C., a product was obtained in a yield of around 5 g.

The boron-containing compounds used in the following Examples are listed below in Table 1.

TABLE 1
B-containing compounds

| Com- | | |
|---|---|---|
| pound | | |
| # | Formula | Source |
| 1 | 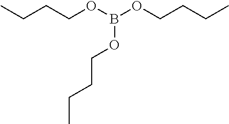 [SMILES: CCCCOB(OCCCC)OCCCC] | Gelest |
| 2 | 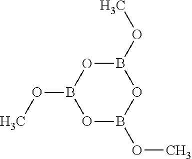 | TCI Chemicals |
| 3 | 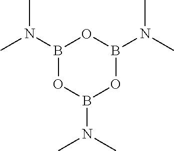 | Chemieliva |
| 4 | 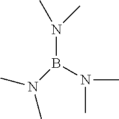 | Sigma-Aldrich |
| 5 | 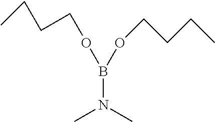 | Preparation Example 1 |
| 6 | 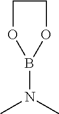 | Preparation Example 2 |
| 7 | 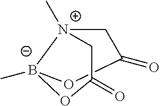 | Sigma-Aldrich |
| 8 | 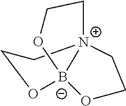 [SMILES: C1C[N+]23CCO[B-]2(O1)OCC3] | Sigma-Aldrich |
| 9 | 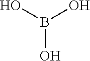 | Sinopharm |
| 10 | 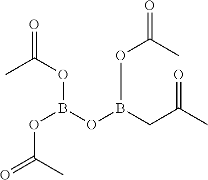 [SMILES: CC(=O)CB(OB(OC(C)=O)OC(C)=O)OC(C)=O] | Preparation Example 3 |

### General Procedures for Preparing Silicone Pressure Sensitive Adhesive Compositions

The boron-containing additive in an amount as shown below in the Examples, 1.5 parts by weight of dibenzoyl peroxide, and 1.2 parts by weight of SR545 silicone resin additive (from Momentive Performance Materials) were dispersed uniformly into 100 parts by weight (dry weight) of SilGrip™ PSA610 (from Momentive Performance Materials), a toluene solution of silicone pressure sensitive adhesive, to obtain a silicone pressure sensitive adhesive composition.

### General Procedures for Preparing Silicone Pressure Sensitive Adhesive Tapes

The silicone pressure sensitive adhesive composition with a solid content of 40% was applied on a 25 μm PET thin film pre-coated with SilForce™ SS4191A primer (from Momentive Performance Materials), dried at 85° C. for 2 minutes, and then cured at 170° C. for 2 minutes to obtain a silicone pressure sensitive adhesive tape. The thickness of the dried and cured adhesive composition on the tape was 25 μm.

### Testing Method for Peel Adhesion (180 Degrees) to Silicone Rubber

The peel adhesion (180 degrees) was measured according to FINAT Test Method No. 1 at 50% relative humidity and 25° C. temperature. The silicone pressure sensitive adhesive tape having a width of 25 mm (1 inch) was attached onto vulcanized silicone rubber LSR2640 (from Momentive Performance Materials) and rolled back and forth once with a roller of 2 kg at a speed of 300 mm/min. After 20 minutes and 72 hours, the tape was peeled from the silicone rubber at an angle of 180° and at a speed of 300 mm/min to measure the peel adhesion.

### Examples 1 to 10

Each of the additives as shown in Table 2 below was used in an amount of 6 parts by weight to prepare silicone pressure sensitive adhesive compositions and the adhesive compositions were coated onto the PET thin film to prepare silicone pressure sensitive adhesive tapes using the general procedures discussed above. The tapes were tested for peel adhesion at 180 degrees after 20 minutes and 72 hours, respectively.

TABLE 2
Peel Adhesion of B-containing Compound Alone

Peel Adhesion (gf/inch)

| Example # | Compound # | 20 minutes | 72 hours |
|---|---|---|---|
| Reference* | — | 246 | 250 |
| 1 | 1 | 526 | 633 |
| 2 | 2 | 585 | 975 |
| 3 | 3 | 707 | 1158 |
| 4 | 4 | 913 | 1358 |
| 5 | 5 | 918 | 1631 |
| 6 | 6 | 593 | 1058 |
| 7 | 7 | 245 | 250 |
| 8 | 8 | 341 | 462 |
| 9 | 9 | 516 | 544 |
| 10 | 10 | 529 | 595 |

*No B-containing compound or SR545 silicone resin was used in the Reference Example.

It can be seen from Table 2 that Compounds 2 to 6 alone provided the silicone pressure sensitive adhesive composition with a greatly improved peel adhesion to silicone rubber as compared to Compound 1 under the same conditions.

### Example 11 to 19

Each of the additives as shown in Table 3 below was used in an amount of 0.17 parts by weight in combination of 6 parts by weight of Compound 1 to prepare the silicone pressure sensitive adhesive compositions and the adhesive compositions were coated onto the PET thin film to prepare silicone pressure sensitive adhesive tapes using the general procedures discussed above. The tapes were then tested for peel adhesion at 180 degrees after 20 minutes and 72 hours, respectively.

TABLE 3
Peel Adhesion of B-containing Compound in Combination

Peel Adhesion (gf/inch)

| Example # | Compound # | 20 minutes | 72 hours |
|---|---|---|---|
| Reference | — | 246 | 250 |
| 11 | 2 | 517 | 1244 |
| 12 | 3 | 486 | 1055 |
| 13 | 4 | 424 | 851 |
| 14 | 5 | 350 | 783 |
| 15 | 6 | 405 | 903 |
| 16 | 7 | 552 | 663 |
| 17 | 8 | 527 | 1058 |
| 18 | 9 | 616 | 1298 |
| 19 | 10 | 341 | 558 |

It can be seen from Tables 2 and 3 that Compounds 2, 7, 8 and 9 in combination with Compound 1 respectively achieved a synergistic effect as any one of these combinations provided the silicone pressure sensitive adhesive composition with a peel adhesion to silicone rubber higher than the corresponding adhesion obtained when they were used alone. The combination of Compounds 2, 8 and 9 with Compound 1 achieved a further improved peel adhesion to silicone rubber which is unexpectedly higher than 1000 gf/inch. In terms of the appearance, the silicone pressure sensitive adhesive composition using Compound 2 was clear when used in combination with Compound 1. Compounds 7, 8 and 9 were less clear compared to Compound 2, possibly due to their polar natures, when used in combination with Compound 1.

### Example 20

The silicone pressure sensitive adhesive composition prepared in Example 11 was aged for eight weeks at room temperature and at a temperature of 40° C., respectively. The variation of viscosity and appearance of the adhesive composition with time was shown in Table 4 below.

The silicone pressure sensitive adhesive composition after aging for eight weeks was coated to the PET thin film to prepare silicone pressure sensitive adhesive tapes using the general procedures discussed above. The adhesive tapes were then tested for peel adhesion to silicone rubbers at 180 degrees after 20 minutes, 24 hours and 72 hours, respectively. The results of the peel adhesion of the aged adhesive composition are shown in FIG. 1 in comparison with the freshly prepared adhesive composition without ageing. In FIG. 1, in each of the three triplets, the left bar represents the fresh sample without aging, the middle bar represents the sample aged at room temperature, and the right bar represents the sample aged at 40° C.

TABLE 4
Viscosity and Appearance Results of the Adhesive Composition

| | Initial | 1 week | 3 weeks | 4 weeks | 6 weeks | 8 weeks |
|---|---|---|---|---|---|---|
| RT Aging | | | | | | |
| Viscosity (cps) | 1.33 | 1.33 | 1.34 | 1.34 | 1.34 | 1.35 |
| Appearance | Clear | Clear | Clear | Clear | Clear | Clear |
| 40° C. Aging | | | | | | |
| Viscosity (cps) | 1.34 | 1.34 | 1.35 | 1.36 | 1.36 | 1.37 |
| Appearance | Clear | Clear | Clear | Clear | Clear | Clear |

It can be seen from Table 4 that viscosity and appearance of the composition remained substantially unchanged over time at both room temperature and at an elevated temperature of 40° C.

Further, it can be seen from FIG. 1 that the peel adhesion to silicone rubbers obtained from the freshly prepared sample without aging and from the samples aged at different temperatures (room temperature and an elevated temperature of 40° C.) were substantially the same.

All of the above results showed that the silicone pressure sensitive adhesive composition of the present invention had an excellent stability for both room temperature and high temperature storage.

### Examples 21 to 26

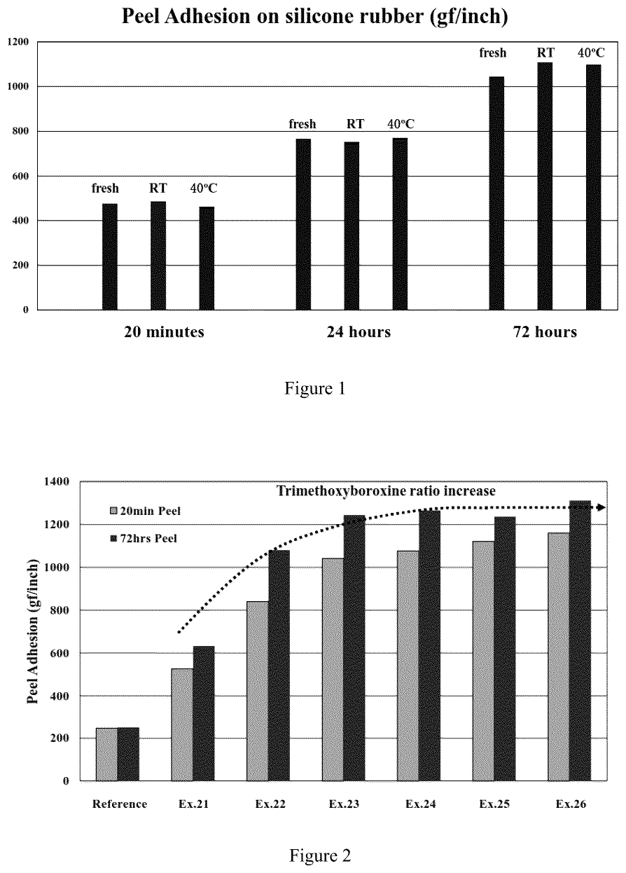

Compound 2 was used in combination with Compound 1 in varying amounts as shown in Table 5 to prepare the silicone pressure sensitive adhesive compositions. The adhesive compositions were coated onto the PET thin film to prepare silicone pressure sensitive adhesive tapes using the general procedures discussed above. The tapes were then tested for peel adhesion at 180 degrees after 20 minutes and 72 hours, respectively. The results are shown in Table 5 and FIG. 2.

TABLE 5
Peel Adhesion of B-containing Compounds with Varying Ratios

| | Compound 1 | Compound 2 | | |
|---|---|---|---|---|
| | (parts by | (parts by | Peel Adhesion | |
| Example # | weight) | weight) | 20 minutes | 72 hours |
| Reference | 0 | 0 | 246 | 250 |
| 21 | 6.00 | 0 | 526 | 633 |
| 22 | 6.08 | 0.08 | 841 | 1080 |
| 23 | 6.00 | 0.17 | 1042 | 1244 |
| 24 | 5.87 | 0.30 | 1076 | 1265 |
| 25 | 5.57 | 0.60 | 1121 | 1237 |
| 26 | 4.97 | 1.20 | 1160 | 1312 |

Surprisingly, it was found that the improvement of the peel adhesion to silicone rubbers provided by Compound 2 was not proportional to the amount thereof, as shown by Table 5 and also illustrated in FIG. 2. The maximum improvement of the peel adhesion provided by Compound 2 could be achieved at a very low weight ratio level of about 1:35 (Compound 2: Compound 1). Such a technical effect is beneficial for further lowing the loading of additive in order to achieve the desired peel adhesion to low energy surface.

### Example 27

The silicone pressure sensitive adhesive tapes prepared according to the Reference Example and Example 23 were each attached to a fluoro release film FL132 (from Housewell) to form laminates. Next, the laminates were aged at room temperature and a temperature of 40° C., respectively, and were then tested at room temperature for release force (180 degrees) to the release liner FL132 every week according to FINAT Test Method No. 3 (low speed release force) using the procedures described below.

The laminate was fixed with double sided adhesive covering the full test area of the laminate, and rolled back and forth once with a roller of 2kg at a speed of 300 mm/min. Next, the laminate was peeled apart at an angle of 180° and at a speed of 300 mm/min to measure the release force required to separate the release film from the pressure sensitive adhesive tape.

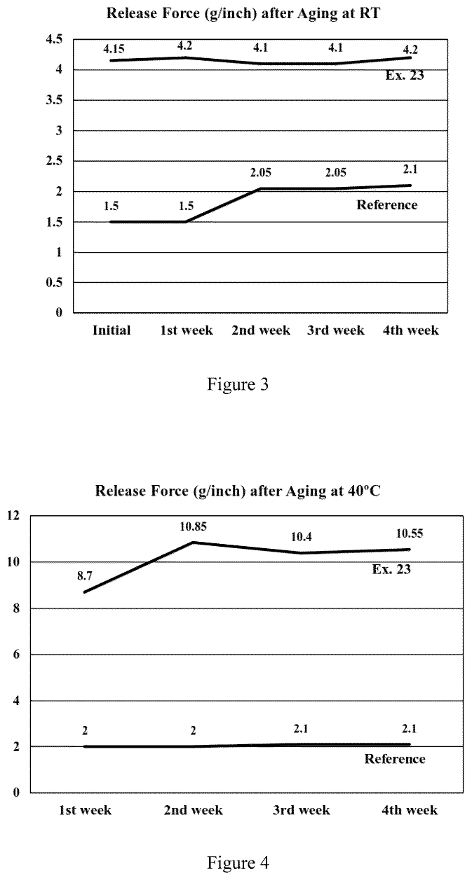

The results of the measured release force are illustrated in FIG. 3 (room temperature) and FIG. 4 (40° C. temperature). The results showed that the silicone pressure sensitive adhesive compositions of the present invention had more suitable release force to conventional release film, and the release force remained substantially stable over time at room temperature and at an elevated temperature of 40° C.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A silicone pressure sensitive adhesive composition comprising:
at least one boron-containing additive comprising a boron-containing compound selected from the group consisting of a boroxine-based compound and a borane-based compound containing a covalent boron-nitrogen bond.

2. The silicone pressure sensitive adhesive composition of claim 1 wherein the boroxine-based compound is of general formula (I): 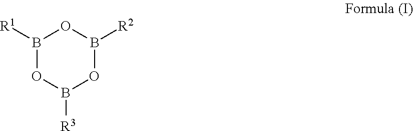
wherein R¹, R² and R³ each independently is a hydrogen atom; a hydroxyl; or a monovalent group having up to 30 carbon atoms selected from the group consisting of an alkyl group, an alkoxy group, a hydroxylalkyl, an alkoxyalkyl, or —R⁸—N(R⁹)(R¹⁰) where R⁸ is a direct bond or a divalent linking group, and R⁹ and R¹⁰ each independently is a hydrogen atom, an alkyl, a hydroxylalkyl, or an alkoxyalkyl.

3. The silicone pressure sensitive adhesive composition of claim 2 wherein R¹, R² and R³ each independently is a monovalent group having up to 20 carbon atoms selected from the group consisting of an alkoxy group, an alkoxyalkyl, or —R⁸—N(R⁹)(R¹⁰) where R⁸ is a direct bond, an alkylene group or an oxyalkylene group, and R⁹ and R¹⁰ each independently is a hydrogen atom, an alkyl, or an alkoxyalkyl.

4. The silicone pressure sensitive adhesive composition of claim 1 wherein the boroxine-based compound has general formula (I-1) or general formula (I-2): 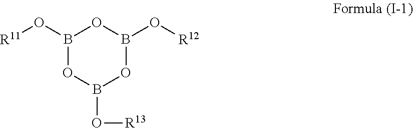
wherein R¹¹, R¹² and R¹³ each independently is a monovalent group having up to 20 carbon atoms selected from the group consisting of an alkyl, or —R¹⁴—N(R¹⁵)(R¹⁶) where R¹⁴ is an alkylene group, and R¹⁵ and R¹⁶ each independently is a hydrogen atom, an alkyl, or an alkoxyalkyl; 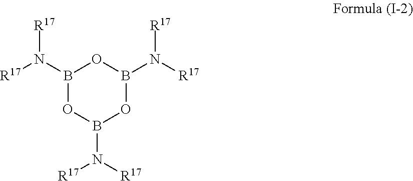
wherein each R¹⁷ is independently an alkyl or an alkoxyalkyl having up to 20 carbon atom, or a hydrogen atom.

5. The silicone pressure sensitive adhesive composition of claim 1 wherein the borane-based compound containing a covalent boron-nitrogen bond has general formula (II): 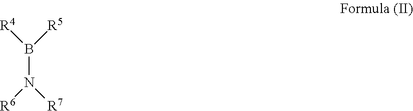
wherein R⁴ and R⁵ each independently is a monovalent group having up to 30 carbon atoms selected from the group consisting of an alkyl group, alkoxy group, a hydroxylalkyl, an alkoxyalkyl, and —R⁸ —N(R⁹)(R¹⁰) where R⁸ is a direct bond or a divalent linking group, and R⁹ and R¹⁰ each independently is a hydrogen atom, an alkyl, a hydroxylalkyl, or an alkoxyalkyl;
optionally R⁴ and R⁵ taken together form a ring containing an alkylene group of up to 10 carbon atoms bonded to the B atom of Formula (II) via an oxygen atom; and
wherein R⁶ and R⁷ each independently is an alkyl, a hydroxylalkyl or an alkoxyalkyl each independently having up to 30 carbon atoms, or a hydrogen atom.

6. The silicone pressure sensitive adhesive composition of claim 5 wherein the borane-based compound containing a covalent boron-nitrogen bond has general formula (II-1): 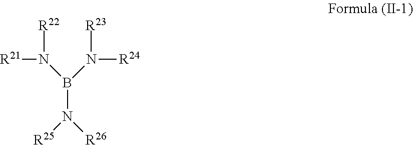
wherein R²¹, R²², R²³, R²⁴, R²⁵ and R²⁶ each independently is a an alkyl, a hydroxylalkyl or an alkoxyalkyl each independently having up to 20 carbon atoms, or a hydrogen atom.

7. The silicone pressure sensitive adhesive composition of claim 5 wherein the borane-based compound containing a covalent boron-nitrogen bond has general formula (II-2): 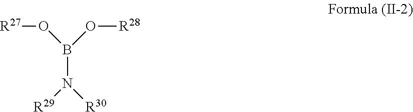
wherein R²⁷ and R²⁸ each independently is a monovalent group having up to 20 carbon atoms selected from an alkyl, or —R³¹—N(R³²)(R³³) where R³¹ is an alkylene group, and R³² and R³³ each independently is a hydrogen atom, an alkyl, or an alkoxyalkyl;
optionally R²⁷ and R²⁸ taken together form a ring containing an alkylene group of 1 to 6 carbon atoms bonded to the O atom of Formula (II-2); and
wherein R²⁹ and R³⁰ each independently is a an alkyl, a hydroxylalkyl or an alkoxyalkyl each independently having up to 20 carbon atoms, or a hydrogen atom.

8. The silicone pressure sensitive adhesive composition of claim 7 wherein R²⁷ and R²⁸ taken together form a ring containing —CH₂CH₂—, —CH₂CH₂CH₂—, —CH₂CH(CH₃)—, —CH(CH₃)CH(CH₃)—,
—CH₂CH(CH₃)CH₂—, or —CH₂C(CH₃)₂CH₂— bonded to the O atom of formula (II-2).

9. The silicone pressure sensitive adhesive composition of claim 1 wherein the at least one boron-containing additive further comprises an acyclic boric compound selected from the group consisting of boric acid, an acyclic borate compound, and combinations thereof.

10. The silicone pressure sensitive adhesive composition of claim 9 wherein the acyclic borate compound is selected from the group consisting of trialkyl borate.

11. The silicone pressure sensitive adhesive composition of claim 9 wherein a weight ratio of said boron-containing compound to said acyclic boric compound is from about 1:100 to about 1:1.

12. The silicone pressure sensitive adhesive composition of claim 9 wherein said boron-containing compound is selected from the boroxine-based compound, said acyclic boric compound is selected from the acyclic borate compound, and a weight ratio of said boroxine-based compound to said acyclic borate compound is from about 1:100 to about 1:1.

13. The silicone pressure sensitive adhesive composition of claim 1 wherein the total amount of the at least one boron-containing additive is from about 1 to about 10 weight percent, based on the total weight of the silicone pressure sensitive adhesive composition.

14. A silicone pressure sensitive adhesive composition comprising:
at least one boron-containing additive comprising at least two members selected from the group consisting of:
i) the boron-containing compound as defined in any one of claims 1 to 8 or a cyclic borate compound;
ii) boric acid; and
iii) an acyclic borate compound.

15. The silicone pressure sensitive adhesive composition of claim 14 wherein the at least one boron-containing additive comprises the acyclic borate compound iii) in combination with at least one of the boron-containing compound, the cyclic borate compound or the boric acid.

16. The silicone pressure sensitive adhesive composition of claim 15 wherein the acyclic borate compound is present in an amount of about 50 wt % to about 99 wt % relative to the total amount of the at least one boron-containing additive.

17. The silicone pressure sensitive adhesive composition of claim 14 wherein the at least one boron-containing additive comprises the acyclic borate compound in combination with the boroxine-based compound having general formula (I): 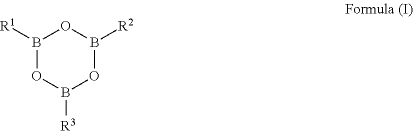
wherein R⁴, R² and R³ each independently is a hydrogen atom; a hydroxyl; or a monovalent group having up to 30 carbon atoms selected from the group consisting of an alkyl group, an alkoxy group, a hydroxylalkyl, an alkoxyalkyl, or —R⁸—N(R⁹)(R¹⁰) where R⁸ is a direct bond or a divalent linking group, and R⁹ and R¹⁰ each independently is a hydrogen atom, an alkyl, a hydroxylalkyl, or an alkoxyalkyl.

18. The silicone pressure sensitive adhesive composition of claim 17 wherein a weight ratio of said boroxine-based compound to said acyclic borate compound is from about 1:100 to about 1:1.

19. The silicone pressure sensitive adhesive composition of claim 14 wherein the at least one boron-containing additive comprises the acyclic borate compound in combination with the cyclic borate compound having generally formula (III): 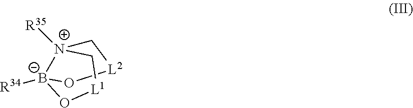
wherein R³⁴ and R³⁵ each independently is an alkyl having 1 to 6 carbon atoms or an aryl having 6 to 12 carbon atoms, optionally, R³⁴ and R³⁵ taken together form a ring containing a divalent group of formula —O—L³—CH₂—, with the —L³— group being bonded to the B atom of formula (III) via the oxygen atom;
L¹, L² and L³ each independently is a divalent group of formula —[C(O)]ₘCₙH₂ₙ— where m is 0 or 1, and n is an integer of 0 to 4, provided that when R³⁴ and R³⁵ taken together form a ring, m defined for at least one of L¹, L² and L³ is 0.

20. The silicone pressure sensitive adhesive composition of claim 1 further comprising
a polyorganosiloxane gum; and
a silicone resin comprising at least one M unit of the formula M=R₃SiO_{1/2}, and at least one unit selected from the group consisting of a T unit of the formula T=RSiO_{3/2} and a Q unit of the formula Q=SiO_{4/2}, and optionally at least one D unit of the formula D=R₂SiO_{2/2}, where R each independently is a monovalent hydrocarbon group of from 1 to 6 carbon atoms; and
optionally a curing catalyst.

21. The silicone pressure sensitive adhesive composition of claim 1 wherein the composition is cured by a radical reaction or a hydrosilylation reaction.

22. An article such as a pressure sensitive adhesive tape comprising the silicone pressure sensitive adhesive composition of claim 1.
